(19) United States
(12) Patent Application Publication
(10) Pub. No.: US 2007/0250548 A1
(43) Pub. Date: Oct. 25, 2007

(54) Systems and methods for displaying a cellular abnormality

(75) Inventors: Ziling Huo, Miami, FL (US); Xi Li, Miami, FL (US); Phaisit Chewputtanagul, Miami, FL (US)

Correspondence Address: BECKMAN COULTER, INC., P.O. BOX 169015, MAIL CODE 32-A02, MIAMI, FL, 33116-9015, US

(73) Assignee: Beckman Coulter, Inc., Fullerton, CA (US)

(21) Appl. No.: 11/408,454

(22) Filed: Apr. 21, 2006

(51) Int. Cl. G06F 17/30

(52) U.S. Cl. 707/203

(57) ABSTRACT

In accordance with the principles of the invention, methods, systems, and computer-readable mediums are provided for processing image data representing cellular analysis result data including accessing image data; generating an intensity histogram based on the image data; transforming the intensity histogram into a stepped image; performing normalized cross-correlation between the stepped image and a reference image to measure similarity; and determining an abnormality based on the measured similarity.

### BACKGROUND OF THE INVENTION

1. Field of the Invention

The present invention relates generally to systems and methods of processing and displaying data and, more specifically, relates to systems and methods for processing and displaying cellular analysis result data and template data in an image.

2. Description of Related Art

In analyzing results of cellular analyzers of a target sample, physicians need to compare the results of the target sample with those of a template and further be able to analyze any abnormalities in the target sample. Conventional cellular analyzers provide for the display of non-processed graphic results in one-dimensional, two-dimensional and three-dimensional displays that only show the target sample using the unprocessed cellular analysis result data. Physicians who analyze the cellular analysis results must view the graphic results while physically comparing the image of the target sample results with the image of a template. These template images may be found in a text book or in a separate image. Alternatively, the physician may have a picture of the template image in his mind. In any case, the physician must take these two separate images and compare the two. This may be difficult because the images may not be on the same scale, in the same form of display, etc. This makes the process of analyzing the target sample data inconvenient, inaccurate, time-consuming, and mind-intensive. Further, the result data from the cellular analyzer is unprocessed and includes noisy, unsmooth data.

As such, there is a need for systems and methods that provide for displaying target sample cellular analysis result data and template data in an image in a manner that enables a physician or user to accurately and efficiently analyze target sample data to identify abnormalities.

### SUMMARY OF THE INVENTION

In accordance with the principles of the invention, as embodied and broadly described herein, methods and systems consistent with the principles of the present invention provide for processing image data representing cellular analysis result data including accessing image data; generating an intensity histogram based on the image data; transforming the intensity histogram into a stepped image; performing normalized cross-correlation between the stepped image and a reference image to measure similarity; and determining an abnormality based on the measured similarity.

### BRIEF DESCRIPTION OF THE DRAWINGS

The patent or application file contains at least one drawing executed in color. Copies of this patent or patent application publication with color drawings will be provided by the Office upon request and payment of the necessary fee.

The accompanying drawings, which are incorporated in and constitute a part of this specification, illustrate several embodiments of the invention and together with the description, serve to explain the principles of the invention, and, together with the description, explain the features and aspects of the invention. In the drawings,

FIG. 1 is an exemplary diagram of a system environment in which systems and methods, consistent with the principles of some embodiments of the present invention, may be implemented;

FIG. 2 is an exemplary diagram of main components of a computer, consistent with some embodiments of the principles of the present invention;

FIG. 3 is an exemplary diagram of components of a server, consistent with the principles of some embodiments of the present invention;

FIG. 4 depicts an exemplary flow diagram of the steps performed by a computer consistent with the principles of some embodiments of the present invention;

FIGS. 5(a) and 5(b) depicts exemplary displays comparing similarity measurements between original histogram images and transformed stepped images consistent with the principles of some embodiments of the present invention;

FIGS. 6(a) and 6(b) depicts an exemplary display provided to a user consistent with the principles of some embodiments of the present invention; and

FIG. 7 depicts an exemplary flow diagram illustrating the steps performed by a computer consistent with the principles of some embodiments of the present invention.

### DETAILED DESCRIPTION

Reference will now be made in detail to the present invention, examples of which are illustrated in the accompanying drawings. Wherever possible, the same reference numbers will be used throughout the drawings to refer to the same or like parts.

Overview

Methods and systems consistent with the principles of some embodiments of the present invention provide for a system that accesses target sample data representing cellular analysis result data. Once the data is accessed, the system processes the data and compares the processed target sample data with the template data. Further, the system may measure a similarity between the processed target sample data and the template data. The measured similarity may be in the form of a score that identifies whether the target sample is normal or abnormal. Further, the abnormal pattern may be flagged based on the score.

Cellular Analysis

The present invention may be used to analyze various types of cells, cellular components, body fluids and/or body fluid components. The present invention is particularly useful in analyzing blood samples, which include both a fluid component (serum) and a solid component (various types of cells). In particular, the invention is directed to analyzing cellular components in a blood sample, either whole blood (which contains various types of blood cells) or a cell component fraction. The present invention may also be used to analyze cells obtained from a tissue sample that are separated from connective tissue and suspended in a biologically compatible liquid medium that does not destroy the cells. The present invention may further be applied to analyze the multi-dimensional cell or particle scatter plot obtained by using conventional hematology or flow cytometry instruments. The terms “cellular analyzer” and “cellular analysis” are intended to cover at least all of the components as described herein. Further, where target sample data is recited, this term is intended to include target sample cellular analysis result data.

Generation of Raw Data

The body fluids and/or cellular components of body fluids and/or whole blood may be subjected to various types of analytical techniques to generate data for analysis and display in accordance with the present invention. The most common techniques are Direct Current to measure the volume of the cell size, Radio Frequency to measure the opacity of the cell, fluorescence, and light scatter to measure the granularity of the cell.

Target Sample Data and Template Data

The target sample data and/or the template data may be in the form of image data including white blood cells (WBC), red blood cells (RBC), platelets, one-dimensional histograms from complete blood count (CBC), WBC differential scattergrams in two and/or three dimensions, reticulocyte differential scattergrams in two and/or three dimensions, nucleated red blood cell (NRBC) differential scattergrams in two or three dimensions, WBC differential histograms in surface image; reticulocyte differential histograms in surface image, NRBC differential histograms in surface image, etc. Alternatively the stored template data may be stored after the raw data has been applied with image smoothing and stepped image transformation.

System Architecture

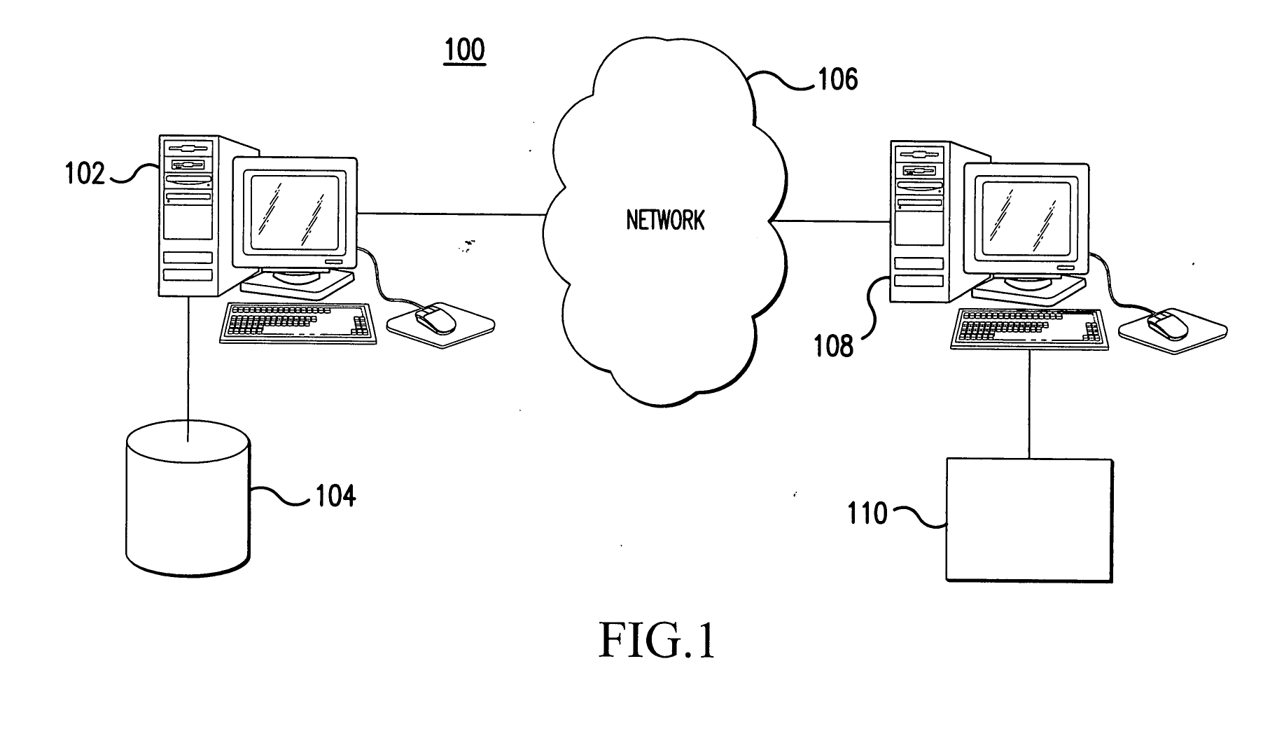

FIG. 1 is an exemplary diagram of a system environment 100 for implementing the principles of the present invention. The components of system 100 may be implemented through any suitable combinations of hardware, software, and/or firmware. As shown in FIG. 1, system 100 includes a user computer 102. User computer 102 may be communicably linked to a database 104. Alternatively, database 104 may reside directly on network 106 or the contents of database 104 may reside directly on computer 102 or server 108.

System 100 may further include network 106 which may be implemented as the Internet, or any local or wide area network, either public or private. System 100 may further include server 108 and server 108 may be communicably linked to analyzer 110. Analyzer 110 may be implemented as Beckman Coulter hematology instruments, such as LH750 and LH500, etc., to generate the test result data.

It may be appreciated by one of ordinary skill in the art that while only one computer 102, database 104, network 106, server 108 and analyzer 110 are depicted, more than one of these types of devices may be implemented in the system consistent with the principles of some embodiments of the present invention. It may further be appreciated that each of these devices may reside in different locations within the system. For example, analyzer 110 may be directly communicably linked to computer 102, wherein computer 102 may receive data from analyzer 110 directly without operating over the network. It may still further be appreciated that features consistent with principles of the present invention may be implemented solely within computer 102 as a stand-alone unit where all of the data needed to perform the present invention may reside directly on computer 102 and wherein target sample data from analyzer 110 may be input by the user through an external device of computer 102.

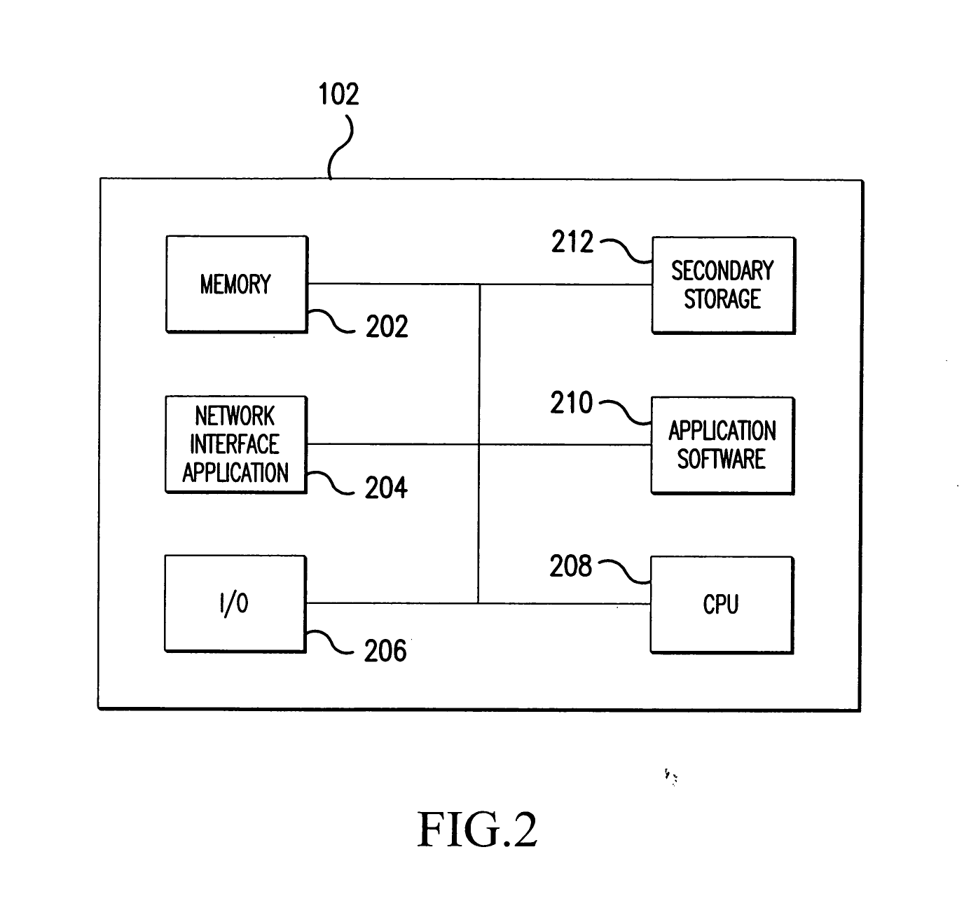

FIG. 2 depicts an exemplary block diagram of components included in computer 102. Computer 102 may be any type of computing device, such as a personal computer, workstation, or personal computing device, and may, for example, include memory 202, network interface application 204, input/output devices 206, central processing unit 208, application software 210, and secondary storage 212. Computer 102 may be communicably linked to database 104, server computer 108 and/or analyzer 110.

A user may access network 106 using the network interface application 204, and/or application software 210. Where network 106 may be implemented as the Internet, network interface application 204 may include a conventional browser including conventional browser applications available from Microsoft or Netscape. Application software 210 may include programming instructions for implementing features of the present invention as set forth herein. Application software 210 may include programming instructions for enabling a user to view and/or analyze test result data wherein target sample data is displayed together with template data. Input/output devices 206 may include, for example, a keyboard, a mouse, a video cam, a display, a storage device, a printer, etc.

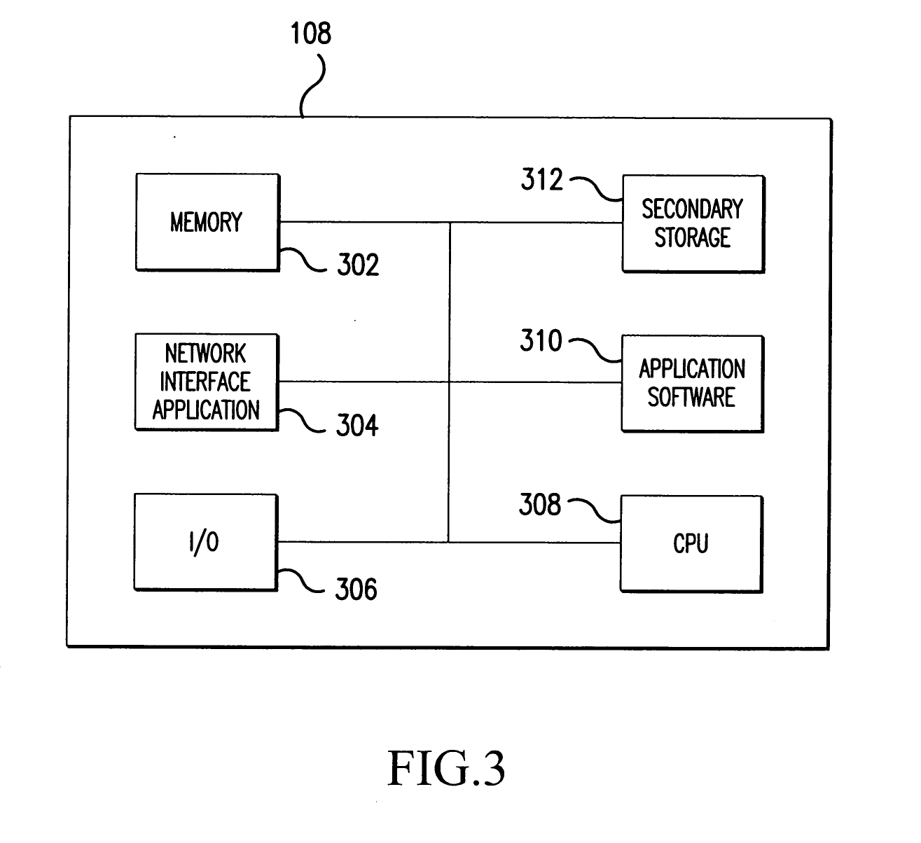

FIG. 3 depicts an exemplary block diagram of the components included in server computer 108. Server computer 108 may include memory 302, network interface application 304, input/output devices 306, central processing unit 308, application software 310, and secondary storage 312 consistent with the principles of some embodiments of the present invention. The components of server computer 108 may be implemented similarly with the components of computer 102.

Functionality

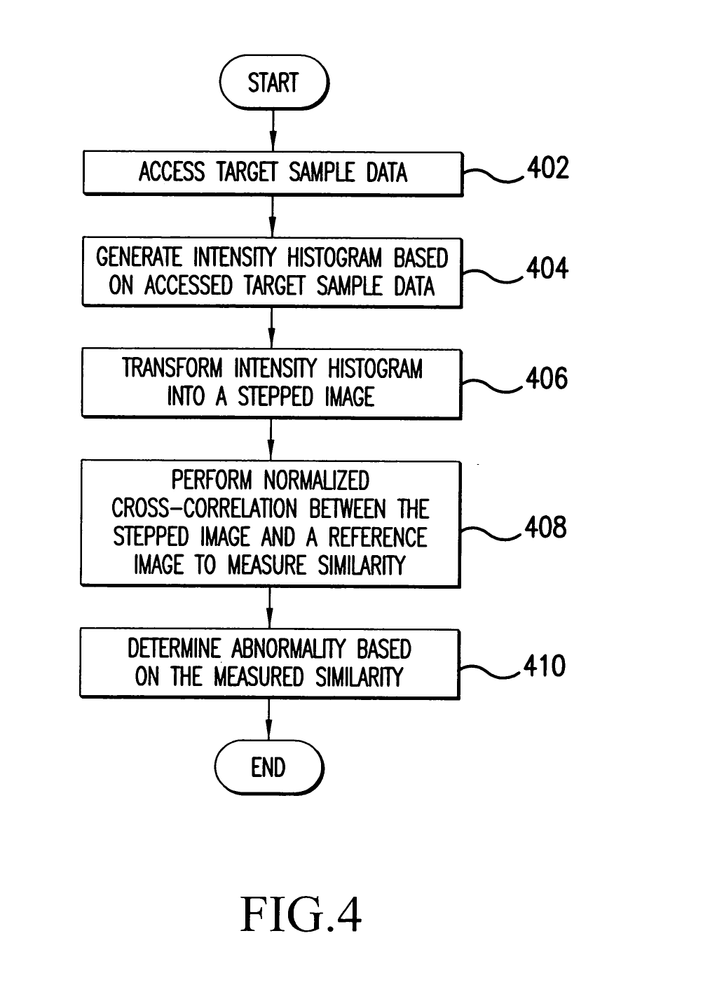

FIG. 4 depicts an exemplary flow diagram of the steps performed by computer 102, consistent with some embodiments of the present invention. As shown in FIG. 4, upon identification of the target sample data by the user to analyze, computer 102, through application software 310, accesses target sample data (Step 402). Target sample data may be data representing analysis results of cells performed by analyzer 110. This data may be stored on computer 102, stored in database 102, or on server 108. The system then generates an intensity histogram based on the accessed target sample data (Step 404). The intensity histogram may be generated by processing the raw image data from the cellular analyzer using a filter, for example, a low pass filter, in order to remove the noise and smooth the image. A density compensation function may then be obtained, wherein the pixel values are equalized in order to improve the appearance.

The intensity histogram is then transformed by the system into a stepped image (Step 406). In order to generate the stepped image, a plurality of levels, for example, four levels, of threshold are performed to obtain the stepped image. Using the stepped image, the systems performs a normalized cross-correlation between the stepped image and a reference image, or template data, to measure similarity (Step 408). This may be performed using a Fast Fourier Transform (FFT) based technique. Compared with the conventional cross-correlation algorithm, the FFT based method is more computationally efficient especially when the data size is large. Template data represents standard data to which the target sample is compared. Template data may represent, for example, an average of many samples, an average of many samples where extraneous data is removed, etc. Template data may be stored on computer 102, stored in database 102, or on server 108. The measured similarity may be in the form of a score where if the score is high, then the target sample is normal. If the score is low, or below a predetermined threshold, then the target sample is abnormal (Step 410).

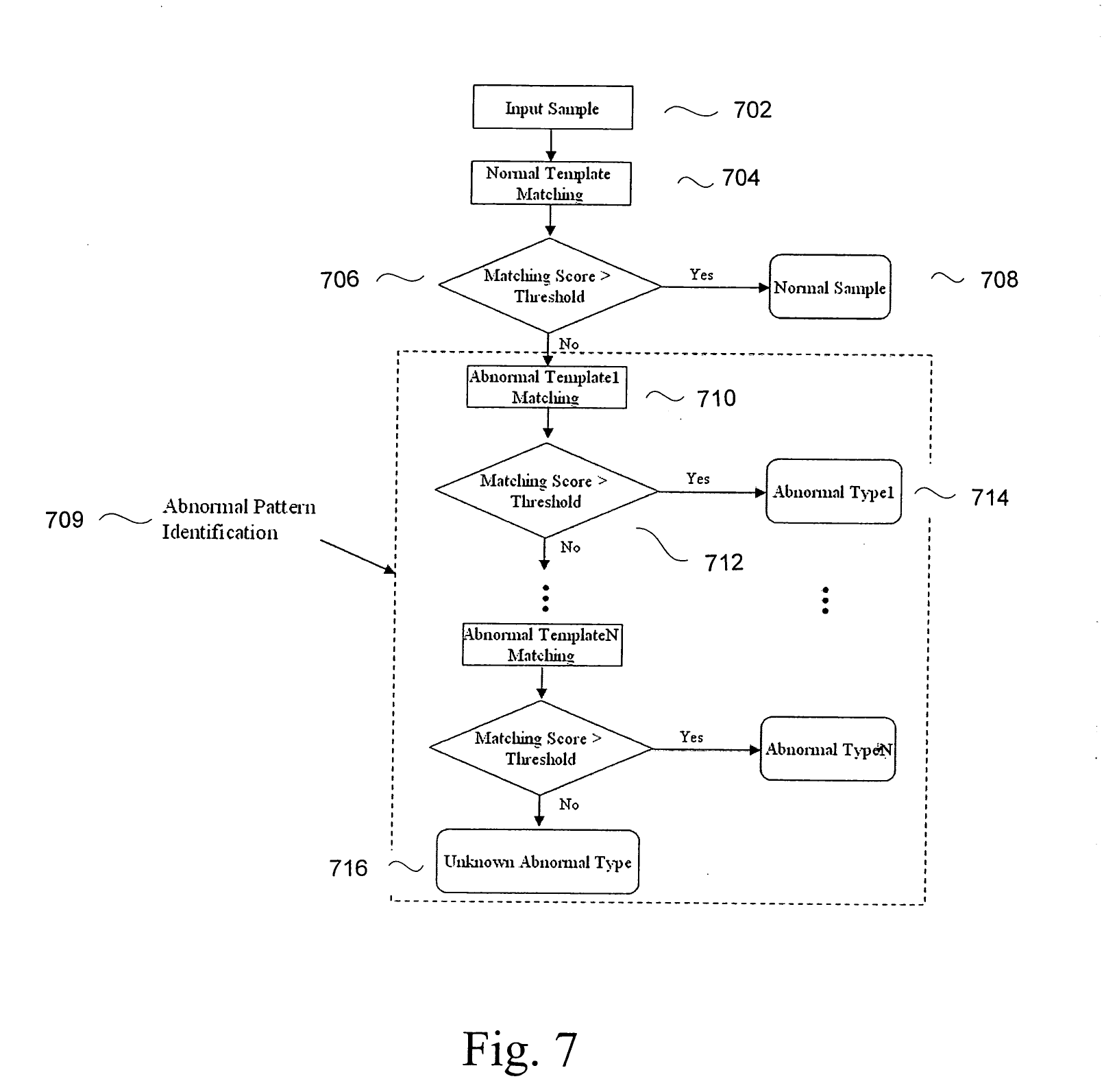

FIG. 7 depicts an exemplary flow diagram of steps performed by client computer 104 in determining correlation. Client computer 104 accesses the sample (Step 702). After the target sample is accessed, client computer 104 performs normal template matching to determine if the target sample is normal (Step 704). If the matching score between the normal template and the target sample is above a certain threshold (Step 706, Yes), then computer 104 determines that the target sample is normal (Step 708).

If the matching score between the target sample and the normal template is less than a predetermined threshold, then abnormal template matching is performed (709). During abnormal template matching, the target sample is correlated with at least one abnormal template to identify an abnormality. For example, the target sample is matched with abnormal template 1 (Step 710). If the matching score is greater than a predetermined threshold (Step 712, Yes), then the target sample is determined to have an abnormality of type 1 (Step 714). This process may be repeated for a plurality of abnormal templates. If the matching score is not greater than a predetermined threshold for any of the abnormal templates matched, then the target sample is determined to have an unknown abnormality (Step 716).

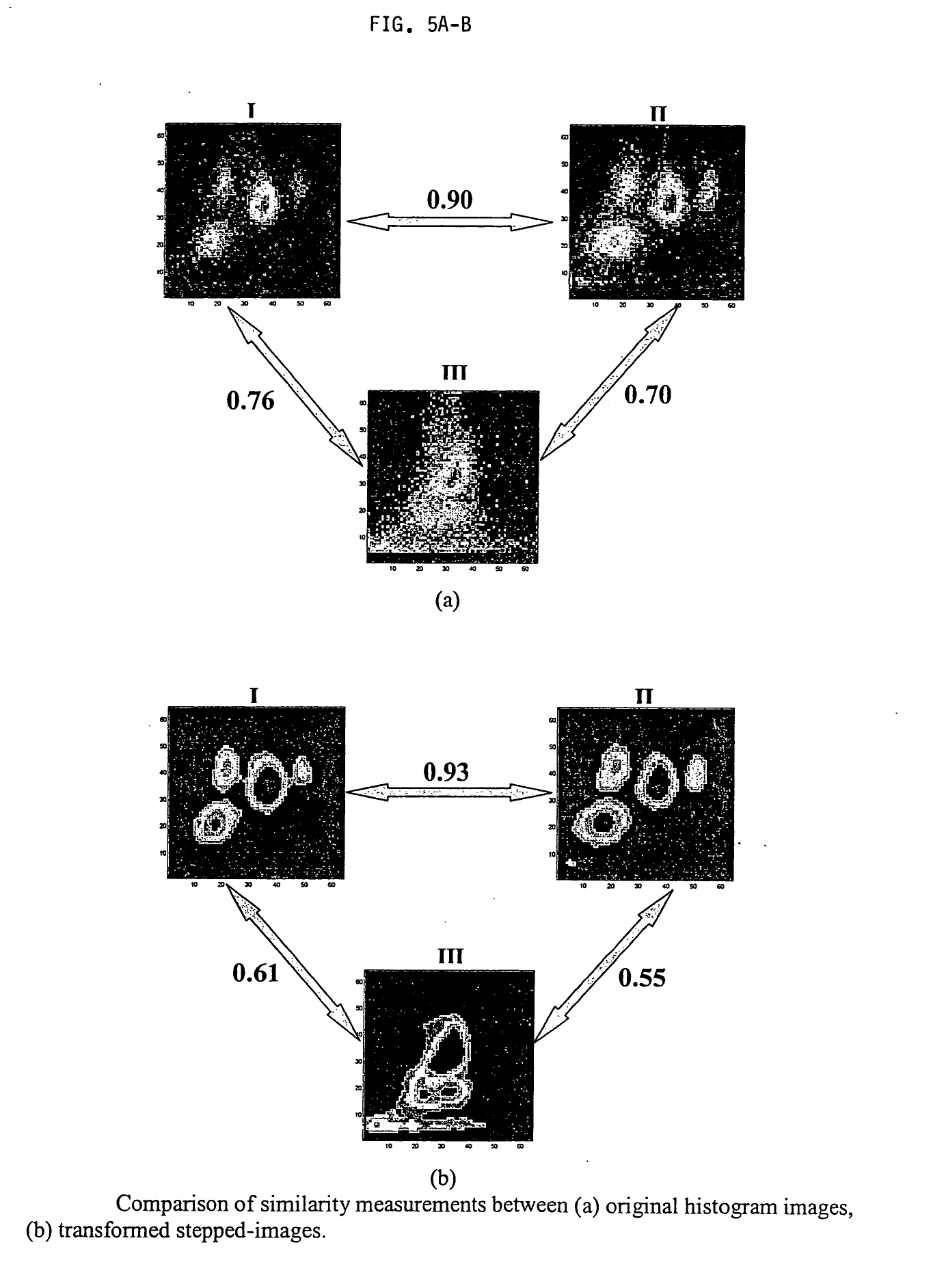

FIG. 5(a)-(b) depicts an example of the difference between original histogram data from the cellular analysis result data and the processed cellular analysis result data consistent with principles of some embodiments of the present invention. As shown in FIG. 5(a)-(b), the original histogram images are depicted in FIG. 5(a) and the transformed stepped images are depicted in FIG. 5(b). Images I and II in FIG. 5(a) both present a normal pattern. However, the intensities of each population are varied. Image III in FIG. 5(a) is a sample with an abnormal pattern. The cross-correlation coefficients which are used to measure the similarity between the two images are show next to the arrows. FIG. 5(b) shows the results based on the transformed stepped images consistent with the principles of some embodiments of the present invention. As can be seen in the figure, the similarity measurement between the two normal samples (images I and II) is increased. In contrast, the similarity measurements between normal samples and the abnormal sample (Image III) is decreased significantly.

As can be seen from FIGS. 5(a) and (b), the stepped image transformation can compensate the intensity variation of the original images. By processing the cellular analysis result data in the manner described herein, instead of using the raw histogram images for template matching more discriminate information may be provided between normal and abnormal patterns. Further, each level of the stepped image is a binary image. Therefore, the user may readily obtain a lot of useful image information, for example, the number of populations at a given level based on analyzing the binary images.

After processing the cellular analysis result data as discussed above, the system may display the data to the user. For example, the system may display the transformed stepped image to the user so that the user may be able to see the processed cellular analysis result data together with the template data within the same image. This will allow the user to visually see how the processed cellular analysis result data compares with the template data. This data is provided in addition to the score representing the measured similarity calculated by the system. Further, the system may display the processed target sample data and the template data for the user to view. The processed target sample data may be displayed using display attribute(s) that are different from the display attributes of the template data. For example, the processed target sample data may be displayed in the one color, texture, level of brightness, etc., while the template data is displayed in a different color, texture, level of brightness etc., so that the user may more easily differentiate between the two data sets. Alternatively, the user may be able to turn on or turn off the display for the template.

Alternatively, a display may be presented to the user including the original histogram data of the cellular analysis result data.

Displays

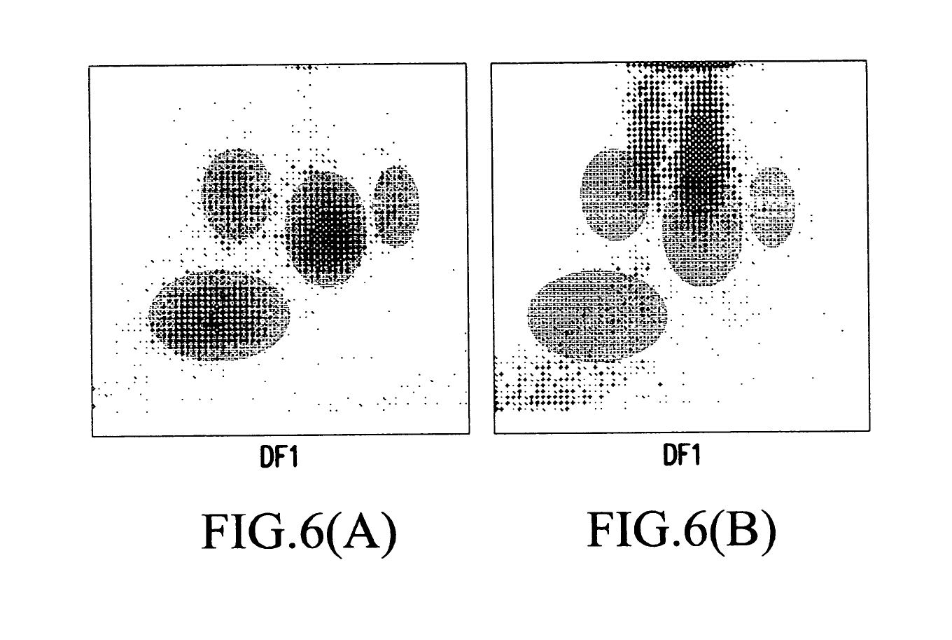

FIGS. 6(a) and (b) depict exemplary displays provided to user upon completion of the process set forth in FIG. 4. FIG. 6(a)-(b) depicts template matching between the processed cellular analysis result data and the template data. The pink shadow areas indicate the location of the normal sample template and the black dots represent the processed cellular analysis result data. FIG. 6(a) depicts a sample where there is a high matching score, indicating a normal sample. FIG. 6(b) depicts a sample with a low matching score, indicating an abnormal sample.

Template Data

The template data used within system 100 may be standard template data or may be customizable by the physician. The template data may represent a normal and healthy sample or an abnormal sample. Standard template data is data that may be deliberately selected and processed using thousands of samples. Further, by using a present template, noise and bias may be removed and, ultimately, are more objective than that summarized by any user. Further, there may be different template data for each variable in an analysis, providing for a multi-variate or multi-parameter analysis. In addition, there may be different templates representing in one-dimensional, two-dimensional, or three-dimensional form in order to provide more data to compare with the target sample data. In order to provide the template data in accordance with the present invention, it is possible to obtain multiple specific disease templates with a current patient sample or target sample.

By providing the template data as discussed herein, the target sample may be compared with the template in order to identify abnormalities in the target sample based on, for example, special graphic patterns that may appear in the display. These abnormalities may include chronic lymphocytic leukemia (CLL), acute lymphocytic leukemia (ALL), chronic myologenous leukemia (CML), acute myologenous leukemia (AML), defects in hemoglobin, for example, Thalassemia, etc., sickle cell crisis, etc.

### CONCLUSION

Modifications and adaptations of the present invention will be apparent to those skilled in the art from consideration of the specification and practice of the invention disclosed herein. The foregoing description of an implementation of the invention has been presented for purposes of illustration and description. It is not exhaustive and does not limit the invention to the precise form disclosed. Modifications and variations are possible in light of the above teachings or may be acquired from the practicing of the invention. For example, the described implementation includes software, but systems and methods consistent with the present invention may be implemented as a combination of hardware and software or hardware alone.

Additionally, although aspects of the present invention are described for being stored in memory, one skilled in the art will appreciate that these aspects can also be stored on other types of computer-readable media, such as secondary storage devices, for example, hard disks, floppy disks, or CD-ROM; the Internet or other propagation medium; or other forms of RAM or ROM.

We claim:

1. A method of processing image data representing cellular analysis result data comprising:
accessing image data;
generating an intensity histogram based on the image data;
transforming the intensity histogram into a stepped image;
performing normalized cross-correlation between the stepped image and a reference image to measure similarity; and
determining an abnormality based on the measured similarity.

2. The method of claim 1, wherein generating the intensity histogram includes generating a density compensation function to equalize the image data.

3. The method of claim 2, wherein transforming the intensity histogram includes thresholding the equalized image data.

4. The method of claim 1, wherein generating the intensity histogram includes low pass filtering the accessed image data.

5. The method of claim 1, wherein the abnormality is determined based on the measured similarity falling below a predetermined threshold.

6. The method of claim 1, wherein the reference image is accessed from a database including a plurality of reference images representing a plurality of abnormal patterns.

7. The method of claim 1, wherein a flagging process is performed based on the stepped image, a pattern shift estimate, and the measured similarity to identify a pattern in the stepped image.

8. The method of claim 1, wherein the stepped image and the reference image are displayed on a display and wherein the stepped image is displayed using a first display attribute and the reference image is displayed using a second display attribute.

9. A system of processing image data representing cellular analysis result data comprising:
a memory for storing instructions; and
a processor, executing the instructions, to perform a method including:
accessing image data;
generating an intensity histogram based on the image data;
transforming the intensity histogram into a stepped image;
performing normalized cross-correlation between the stepped image and a reference image to measure similarity; and
determining an abnormality based on the measured similarity.

10. The system of claim 9, wherein generating the intensity histogram includes generating a density compensation function to equalize the image data.

11. The system of claim 10, wherein transforming the intensity histogram includes thresholding the equalized image data.

12. The system of claim 9, wherein generating the intensity histogram includes low pass filtering the accessed image data.

13. The system of claim 9, wherein the abnormality is determined based on the measured similarity falling below a predetermined threshold.

14. The system of claim 9, wherein the reference image is accessed from a database including a plurality of reference images representing a plurality of abnormal patterns.

15. The system of claim 9, wherein a flagging process is performed based on the stepped image, a pattern shift estimate, and the measured similarity to identify a pattern in the stepped image.

16. The system of claim 9, wherein the stepped image and the reference image are displayed on a display and wherein the stepped image is displayed using a first display attribute and the reference image is displayed using a second display attribute.

17. A computer-readable medium for storing instructions, executed by a processor, to perform a method of processing image data representing cellular analysis result data, the method comprising:
accessing image data;
generating an intensity histogram based on the image data;
transforming the intensity histogram into a stepped image;
performing normalized cross-correlation between the stepped image and a reference image to measure similarity; and
determining an abnormality based on the measured similarity.

18. The computer-readable medium of claim 17, wherein generating the intensity histogram includes generating a density compensation function to equalize the image data.

19. The computer-readable medium of claim 18, wherein transforming the intensity histogram includes thresholding the equalized image data.

20. The method of claim 15, wherein generating the intensity histogram includes low pass filtering the accessed image data.

21. The computer-readable medium of claim 17, wherein the abnormality is determined based on the measured similarity falling below a predetermined threshold.

22. The computer-readable medium of claim 17, wherein the reference image is accessed from a database including a plurality of reference images representing a plurality of abnormal patterns.

23. The computer-readable medium of claim 17, wherein a flagging process is performed based on the stepped image, a pattern shift estimate, and the measured similarity to identify a pattern in the stepped image.

24. The computer-readable medium of claim 17, wherein the stepped image and the reference image are displayed on a display and wherein the stepped image is displayed using a first display attribute and the reference image is displayed using a second display attribute.
